(19) United States
(12) Patent Application Publication
(10) Pub. No.: US 2020/0247725 A1
(43) Pub. Date: Aug. 6, 2020

(54) Cannabis fertilizer

(71) Applicant: Justin Lamoureux, Port Saint Lucie, FL (US)

(72) Inventor: Justin Andre Lamoureux, Port Saint Lucie, FL (US)

(73) Assignee: Justin Andre Lamoureux, Port Saint Lucie, FL (US)

(21) Appl. No.: 16/266,116

(22) Filed: Feb. 4, 2019

(51) Int. Cl. C05F 5/00

(52) U.S. Cl. CPC C05F 5/002

(57) ABSTRACT

A product that aids in cultivation of cannabis, comprised of processed female cannabis flower.

### Description

The use of female cannabis flower as an input material in the manufacture of fertilizers and other cannabis cultivation products using multiple processing means such as extraction of juices, isolation of specific compounds, adding to liquid polymer solutions for slow release, composting, chemically breaking down with acids or bases, degredation of compounds and material by various methods such as the use of worms, microbes, enzymes or other insects for use as an input material for said cannabis cultivation products.

1. I claim a product that aids in cultivation of cannabis, comprised of processed female cannabis flower.
